(19) United States
(12) Patent Application Publication
(10) Pub. No.: US 2025/0235059 A1
(43) Pub. Date: Jul. 24, 2025

(54) DUST COLLECTION DEVICE

(71) Applicant: JIANGSU DONGCHENG TOOLS TECHNOLOGY CO., LTD, Nantong, Jiangsu (CN)

(72) Inventor: Yuanwei Pu, Nantong, Jiangsu (CN)

(21) Appl. No.: 18/700,685

(22) PCT Filed: May 9, 2023
(86) PCT No.: PCT/CN2023/092893

§ 371 Date: Apr. 11, 2024

(30) Foreign Application Priority Data
Jan. 6, 2023 (CN) 202310021757.8

(51) Int. Cl. A47L 9/14; A47L 7/00; A47L 9/12; A47L 9/24; B23Q 11/00

(52) U.S. Cl. CPC A47L 9/1436; A47L 7/0095; A47L 9/12; A47L 9/244; A47L 9/248; B23Q 11/0046; B23Q 11/0071

(57) ABSTRACT

The present disclosure relates to a dust collection device, including a dust collection body and a dust collection box inserted into the dust collection body, where the dust collection body has a connecting part for accommodating the dust collection box; an outer surface of one of a buckle plate of the dust collection box and a first side wall of the connecting part is provided with protruding parts higher than a sealing gasket, and the other one is provided with clamping grooves recessed inwards along an outer surface and matched with the protruding parts; and when the dust collection box is inserted into the dust collection body, the protruding parts slide along the outer surface of one of the first side wall and the buckle plate, such that the friction between the first side wall or the buckle plate and the sealing gasket can be isolated.

### CROSS REFERENCE OF RELATED APPLICATION

This application is a U.S. National Stage under 35 U.S.C. 371 of the International Application PCT/CN2023/092893, filed on May 9, 2023, which claims to Chinese Patent Application No. CN202310021757.8, filed on Jan. 6, 2023, the contents of which are incorporated herein by reference in their entirety.

### TECHNICAL FIELD

The present disclosure relates to the field of dust collection technologies, in particular to a dust collection device used in cooperation with a handheld electric tool.

### BACKGROUND

Dust collection devices are generally used in combination with electric tools. For example, because the electric tools produce dust and debris during drilling operations, the dust collection devices are connected to the electric tools, such that when the electric tools operate, the dust collection devices suck the dust and debris produced by the electric tools to prevent environmental pollution.

For example, a dust collection device is mounted on an electric tool and includes a dust collection box and a dust collection body; and a compensation element is arranged between the dust collection box and the dust collection body, is movable relative to a ventilation chamber in the dust collection body, and has a sealing element arranged to hermetically connect the dust collection box to the dust collection body. During the insertion and extraction of the dust collection box by a user, a sealing gasket and an inner wall of the dust collection body continuously rub against each other, causing the sealing gasket to be damaged due to physical wear. This not only reduces the effect of sealing between the dust collection body and the dust collection box by the sealing gasket, but also shortens the service life of the sealing gasket.

In view of this, it is indeed necessary to provide an improved dust collection device, to overcome the defects existing in the prior art.

### SUMMARY

In view of the deficiencies in the prior art, an objective of the present disclosure is to provide a dust collection device which can reduce the friction between a sealing gasket and a dust collection body to prolong the service life of the sealing gasket.

To solve the existing technical problems, the present disclosure adopts the following technical solution: a dust collection device is provided, including a dust collection body and a dust collection box inserted into the dust collection body, where the dust collection body has a connecting part for accommodating the dust collection box and a ventilation chamber located in the dust collection body, the connecting part has a first side wall attached to the dust collection box, and the first side wall is provided with an opening communicating with the ventilation chamber; the dust collection box has a dust collection seat and a buckle plate arranged on the dust collection seat in a covering manner, and the buckle plate is provided with a penetrating hole matched with the opening and communicating with the dust collection box; an outer surface of at least one of the buckle plate and the first side wall is provided with a sealing gasket protruding outwards;
the outer surface of one of the buckle plate and the first side wall is provided with protruding parts protruding outwards, and the other one is provided with clamping grooves recessed inwards along an outer surface and matched with the protruding parts;
when the dust collection box is inserted into the dust collection body, the protruding parts slide along the outer surface of one of the first side wall and the buckle plate, to isolate the friction between the first side wall or the buckle plate and the sealing gasket; and
when the dust collection box is completely inserted into the dust collection body, the protruding parts are clamped in the clamping grooves, and the sealing gasket is hermetically connected to the opening and the penetrating hole.

Further, the sealing gasket and the protruding parts protrude outwards from the outer surface of the buckle plate; and the clamping grooves are recessed inwards from the outer surface of the first side wall.

Further, the dust collection box further includes an elastic pad hermetically connected between the dust collection seat and the buckle plate; and when the dust collection box is inserted into the dust collection body, the elastic pad pushes and presses the buckle plate towards the dust collection body.

Further, the buckle plate is pivotally or detachably connected to the dust collection seat.

Further, the protruding parts are arranged at a periphery of the sealing gasket and are higher than the sealing gasket.

Further, the sealing gasket is in the shape of a quadrangle; and the four protruding parts are distributed at peripheries of corners of the quadrangle.

Further, a motor is arranged in the ventilation chamber; a filter assembly is accommodated in the dust collection box, is connected to an inner surface of the buckle plate, and blocks the penetrating hole; and the motor generates a negative pressure to suck in an airflow from the dust collection box, and the airflow sequentially passes through the filter assembly, the penetrating hole, the sealing gasket, and the opening.

Further, the sealing gasket and the protruding parts protrude outwards from the outer surface of the first side wall; and the clamping grooves are recessed inwards from the outer surface of the buckle plate.

Further, the sealing gasket protrudes outward and the clamping grooves are recessed inwards from the outer surface of the buckle plate; and the protruding parts protrude outwards from the outer surface of the first side wall.

Further, the sealing gasket protrudes and the clamping grooves are recessed inwards from the outer surface of the first side wall; and the protruding parts protrude outwards from the outer surface of the buckle plate.

Further, the dust collection device includes a telescopic assembly for sucking dust; and the telescopic assembly is at least partially accommodated in the dust collection body, is connected to the dust collection body in a relative sliding manner, and communicates with the dust collection box and the ventilation chamber.

Compared with the prior art, the present disclosure has the following beneficial effects:

According to the present disclosure, the outer surface of one of the buckle plate of the dust collection box and the first side wall of the connecting part is provided with the protruding parts higher than the sealing gasket, and the other one is provided with clamping grooves recessed inwards along an outer surface and matched with the protruding parts; and when the dust collection box is inserted into the dust collection body, the protruding parts slide along the outer surface of one of the first side wall and the buckle plate, such that the friction between the first side wall or the buckle plate and the sealing gasket can be isolated, thereby greatly reducing the physical wear of the sealing gasket and prolonging the service life of the sealing gasket.

In addition, according to the present disclosure, the elastic pad is arranged between the dust collection seat and the buckle plate. During insertion of the dust collection box, the protruding parts slide along the outer surface of one of the first side wall and the buckle plate, and the buckle plate can be shifted towards the dust collection seat by squeezing the elastic pad, to ensure that the dust collection box can be smoothly pushed into the dust collection body; and after the dust collection box is pushed into the dust collection body, the buckle plate causes the sealing gasket to be closely attached to the first side wall by a squeezing force of the elastic pad, thereby further improving the effect of sealing between the buckle plate and the first side wall.

### BRIEF DESCRIPTION OF THE DRAWINGS

The specific embodiments of the present disclosure are further described in detail below with reference to the accompanying drawings.

FIG. 1 is a three-dimensional view of a dust collection device mounted on an electric tool according to a first embodiment of the present disclosure;

FIG. 2 is a sectional view of the dust collection device shown in FIG. 1;

FIG. 3 is a three-dimensional view of separation of a dust collection box from a dust collection body in the dust collection device shown in FIG. 1;

FIG. 4 is a three-dimensional view of a dust collection box in the present disclosure;

FIG. 5 is a three-dimensional view of a buckle plate of a dust collection box in an opened state in the present disclosure, in which an elastic pad is located on the buckle plate;

FIG. 6 is a three-dimensional view of a buckle plate of a dust collection box in an opened state in the present disclosure, in which an elastic pad is located on a dust collection seat;

FIG. 7 is a three-dimensional view of a first side wall and a buckle plate in a dust collection device according to the present disclosure, in which a sealing gasket is located on the buckle plate;

FIG. 8 is a three-dimensional view of a first side wall and a buckle plate in a dust collection device according to the present disclosure, in which a sealing gasket is located on the first side wall;

FIG. 9 is a three-dimensional view of a first side wall and a buckle plate in a dust collection device according to a second embodiment, in which a sealing gasket is located on the buckle plate; and

FIG. 10 is a three-dimensional view of a first side wall and a buckle plate in a dust collection device according to a second embodiment, in which a sealing gasket is located on the first side wall.

### DESCRIPTION OF THE EMBODIMENTS

The terms used in the present disclosure are only for the purpose of describing the specific embodiments and are not intended to limit the present disclosure. The orientations or positional relationships indicated by the terms “upper”, “lower”, “front”, “rear”, etc. below are based on the orientations or positional relationships shown in the accompanying drawings, merely for the convenience of describing the present disclosure and simplifying the description, rather than indicating or implying that the referred device must have a particular orientation or be constructed and operated in a particular orientation, and therefore cannot be understood as limiting the present disclosure.

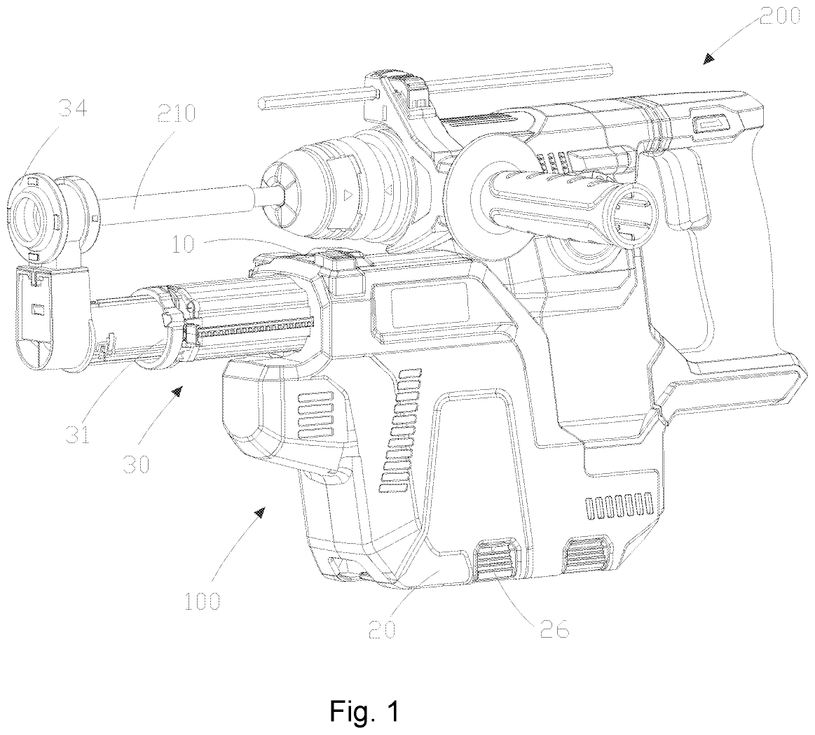

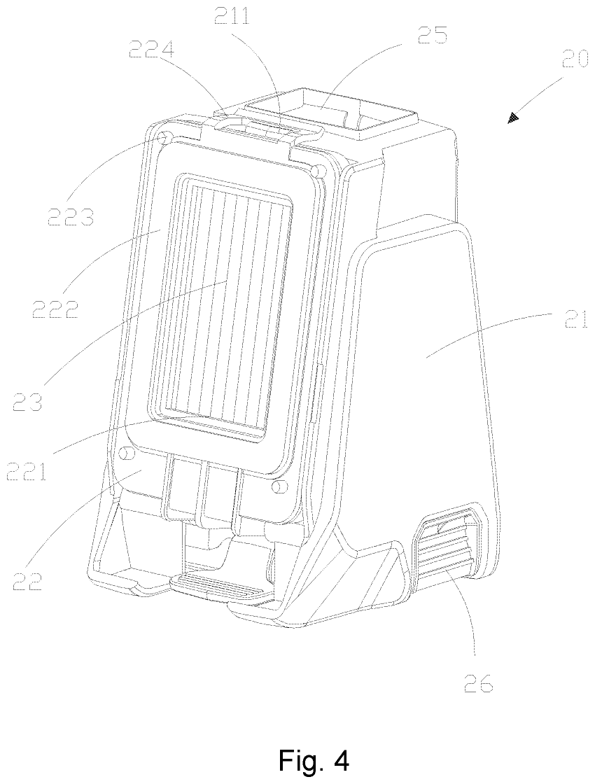

Referring to FIG. 1 to FIG. 8 which show a dust collection device 100 according to a first embodiment of the present disclosure, the dust collection device 100 is mounted on an electric tool 200. In this embodiment, the electric tool 200 is an electric hammer for decoration, chiseling, and other occasions. The electric tool 200 includes a transmission assembly mounted inside the electric tool 200, a drill bit 210 mounted at a front end of the electric tool 200 and driven by the transmission assembly. The dust collection device 100 is inserted into the electric tool 200 and sucks dust and debris produced after processing by the drill bit 210.

The dust collection device 100 includes a dust collection body 10, a ventilation chamber 11 located in the dust collection body 10, a dust collection box 20 inserted into the dust collection body 10, and a telescopic assembly 30 at least partially accommodated in the dust collection body 10. A motor 111 and a fan 112 coaxial with the motor 111 are arranged in the ventilation chamber 11. The motor 111 drives the fan 112 to rotate to form a negative pressure in the ventilation chamber 11, and then an airflow carrying the dust and debris and flowing through the telescopic assembly 30 is sucked through the dust collection box 20.

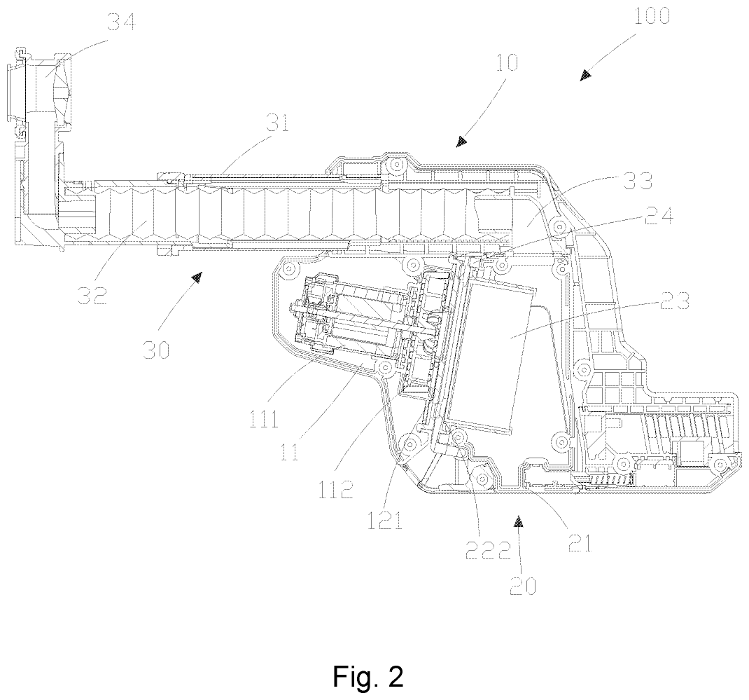

Referring to FIG. 2, the telescopic assembly 30 includes a slip tube 31, a telescopic tube 32, an adapter tube 33, and a dust suction head 34, where the slip tube 31 is supported on the dust collection body 10 in a sliding manner, the dust suction head 34 is fixedly arranged at a front end of the slip tube 31, the drill bit 210 penetrates through the dust suction head 34 for drilling operation, the dust suction head 34 abuts against a processed surface and sucks in the dust, the adapter tube 33 is fixedly arranged in the dust collection body 10, the telescopic tube 32 is sleeved on the adapter tube 33, and the telescopic tube 32 and the adapter tube 33 are accommodated in the slip tube 31. The telescopic assembly 30 extends forward and backward along a processing direction of the electric tool 200 to suck the dust and debris at any time.

Referring to FIG. 2 to FIG. 4, the dust collection body 10 has a connecting part 12 for accommodating the dust collection box 20, and the connecting part 12 has a first side wall 121 defining the ventilation chamber 11 and a second side wall 122 located below the adapter tube 33. An opening 1211 communicating with the ventilation chamber 11 is provided in a center of the first side wall 121; a through hole 1221 communicating with the adapter tube 33 is provided in the second side wall 122; when the dust collection box 20 is inserted into the dust collection body 10, an upper surface of the dust collection box 20 abuts against the second side wall 122; and the upper surface of the dust collection box 20 is provided with an air inlet 25 matched with the through hole 1221. The dust and debris fall into the dust collection box 20 through the telescopic tube 32, the adapter tube 33, the through hole 1221, and the air inlet 25.

The dust collection box 20 has a dust collection seat 21, a filter assembly 23, and a buckle plate 22 arranged on the dust collection seat 21 in a covering manner, where the buckle 22 is provided with a penetrating hole 221 matched with the opening 1211 and communicating with the dust collection box 20.

The filter assembly 23 includes a filter base 231 and a filter net 232 accommodated in the filter base 231, where the filter base 231 abuts against an inner surface of the buckle plate 22, and the filter net 232 covers the penetrating hole 221 and is configured to filter the airflow passing through the filter net 232, to retain the dust and debris, in the airflow, in the dust collection box 20.

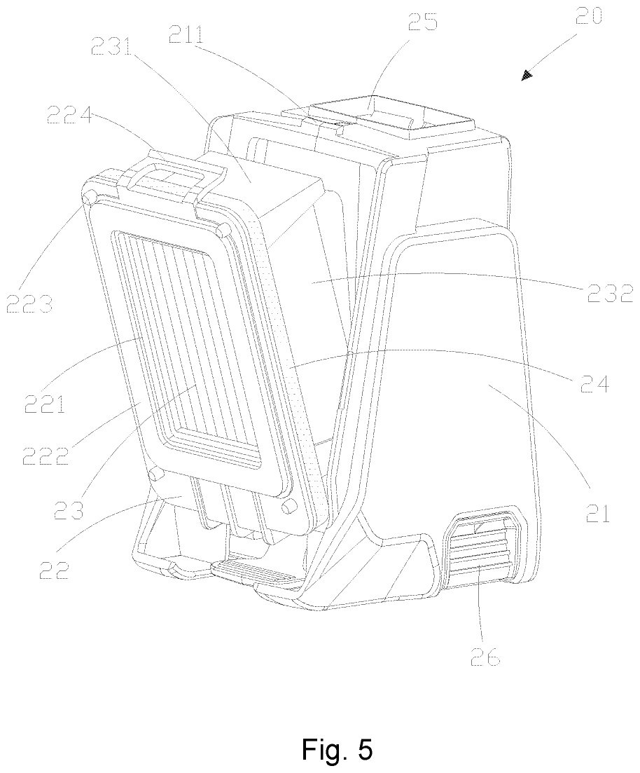

Referring to FIG. 5, one end of the buckle plate 22 is pivotally connected to the dust collection seat 21, and the other end of the buckle plate that is opposite to the pivotable end is provided with a buckle part 224 extending towards the dust collection seat 21. A bulge 211 is arranged on the dust collection seat 21. When the buckle plate 22 is arranged on the dust collection seat 21 in a covering manner, the buckle part 224 is clamped on the bulge 211. When the buckle plate 22 is opened, the dust can be further cleaned or the filter assembly 23 can be replaced. Certainly, the buckle plate 22 may be connected to the dust collection seat 21 in other detachable modes, for example, in a non-pivoting mode, the buckle plate 22 moves directly along a straight line and is arranged on the dust collection seat 21 in a covering manner.

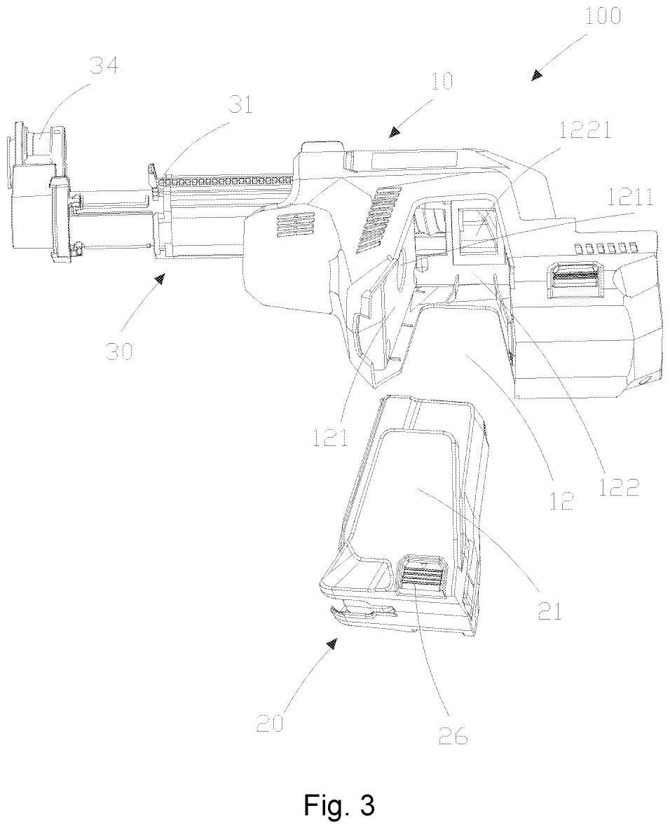

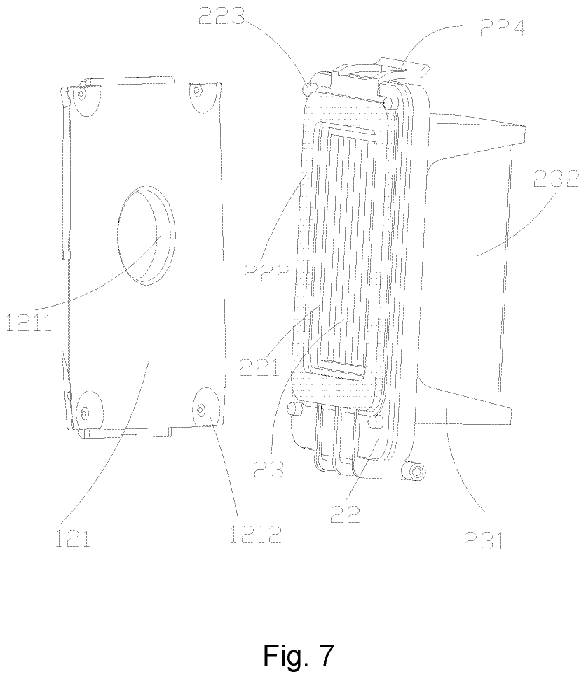

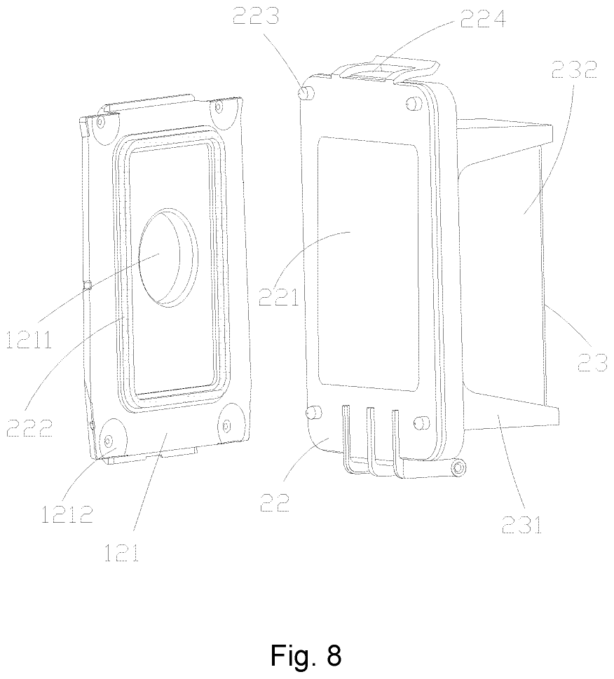

Referring to FIG. 3 and FIG. 7, a sealing gasket 222 is arranged between the buckle plate 22 and the first side wall 121, where the sealing gasket 222 is in the shape of a quadrangle, is fixedly arranged on an outer surface of the buckle plate 22, and is arranged around the penetrating hole 221. The outer surface of the buckle plate 22 is provided with four protruding parts 223 protruding outwards, where the protruding parts 223 are distributed at peripheries of four corners of the sealing gasket 222 and are higher than the sealing gasket 222. The first side wall 121 is provided with clamping grooves 1212 recessed inwards along an outer surface and matched with the protruding parts 223. When the dust collection box 20 is inserted into the dust collection body 10, the protruding parts 223 slide along the outer surface of the first side wall 121, such that the friction between the sealing gasket 222 and the first side wall 121 or the buckle plate 22 is isolated, thereby reducing the physical wear of the sealing gasket 222 and prolonging the service life of the sealing gasket 222. When the dust collection box 20 is completely inserted into the dust collection body 10, the protruding parts 223 are clamped in the clamping grooves 1212, and the sealing gasket 222 is hermetically connected to the opening 1211 and the penetrating hole 221, thereby preventing air leakage between the dust collection box 20 and the dust collection body 10 when the airflow is sucked in. Referring to FIG. 8, in other embodiments, the sealing gasket 222 may be arranged on the outer surface of the first side wall 121.

Referring to FIG. 5, the dust collection box 20 further includes an elastic pad 24 hermetically connected between the dust collection seat 21 and the buckle plate 22, where the elastic pad 24 surrounds a periphery of the filter base 231, and the inner surface of the buckle plate 22 is hermetically connected to a side wall of the dust collection seat 21 through the elastic pad 24, thereby preventing the dust in the dust collection seat 21 from leaking to the outside and preventing the air leakage during the process of sucking in the airflow.

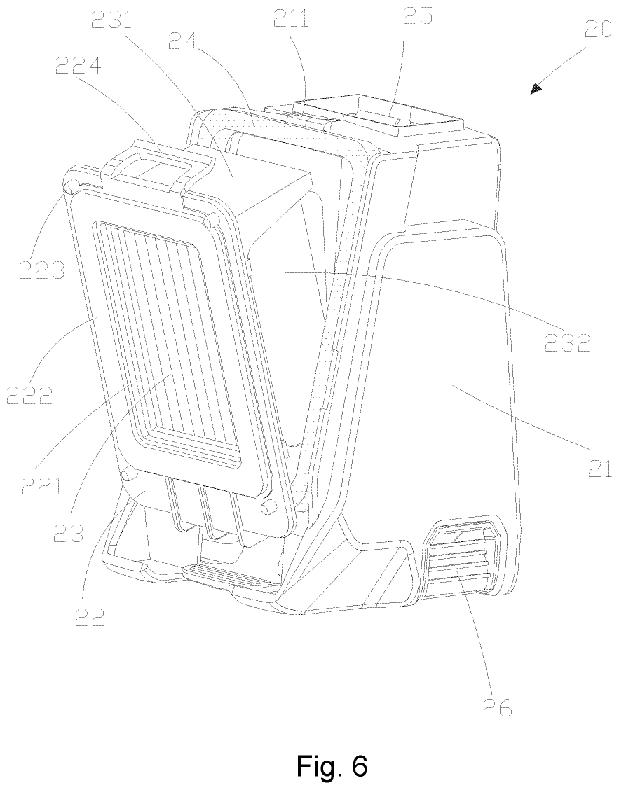

When the dust collection box 20 is completely inserted into the dust collection body 10, the elastic pad 24 pushes and presses the buckle plate 22 towards the dust collection body 10 to provide a press force between the buckle plate 22 and the first side wall 121, thereby further improving the sealing performance. In this embodiment, the elastic pad 24 is attached to the inner surface of the buckle plate 22. Referring to FIG. 6, in other embodiments, the elastic pad 24 may also be attached to the dust collection seat 21.

Referring to FIG. 3, the dust collection box 20 is provided with a pair of clamping parts 26 extending upwards from a bottom wall and located on two sides of the bottom wall. When the protruding parts 223 are matched with the clamping grooves 1212, the clamping parts 26 are clamped with the dust collection body 10 to fix the dust collection box 20 to the dust collection body 10, and then the clamping parts 26 are pressed to dismount the dust collection box 20 from the dust collection body 10, to pour out the dust and debris conveniently and quickly.

According to the present disclosure, the outer surface of one of the buckle plate 22 of the dust collection box 20 and the first side wall 121 of the connecting part 12 is provided with the protruding parts 223 higher than the sealing gasket 222, and the other one is provided with the clamping grooves 1212 recessed inwards along the outer surface and matched with the protruding parts 223; and when the dust collection box 20 is inserted into the dust collection body 10, the protruding parts 223 slide along the outer surface of one of the first side wall 121 and the buckle plate 22, such that the friction between the first side wall 121 or the buckle plate 22 and the sealing gasket 222 can be isolated, thereby greatly reducing the physical wear of the sealing gasket 222 and prolonging the service life of the sealing gasket 222.

In addition, according to the present disclosure, the elastic pad 24 is arranged between the dust collection seat 21 and the buckle plate 22. During insertion of the dust collection box 20, the protruding parts 223 slide along the outer surface of one of the first side wall 121 and the buckle plate 22, and the buckle plate 22 can be shifted towards the dust collection seat 21 by squeezing the elastic pad 24, to ensure that the dust collection box 20 can be smoothly pushed into the dust collection body 10; and after the dust collection box 20 is pushed into the dust collection body 10, the buckle plate 22 causes the sealing gasket 222 to be closely attached to the first side wall 121 by a squeezing force of the elastic pad 24, thereby further improving the effect of sealing between the buckle plate 22 and the first side wall 121.

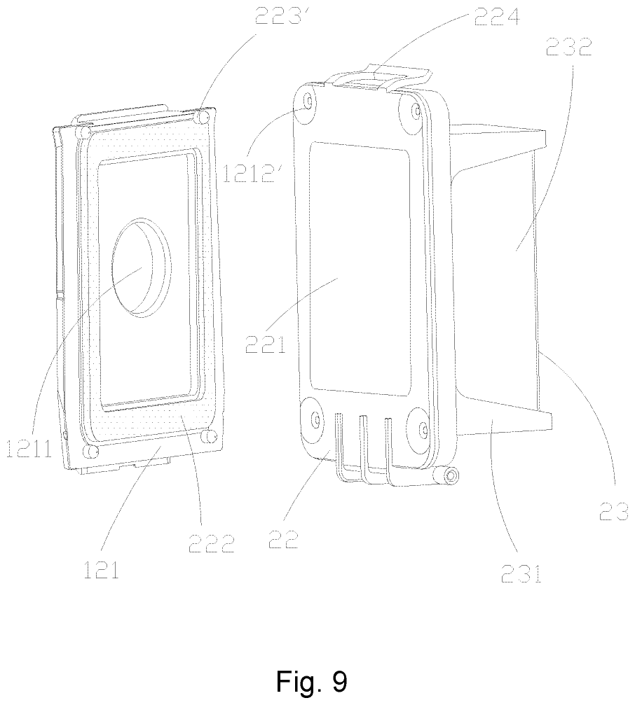

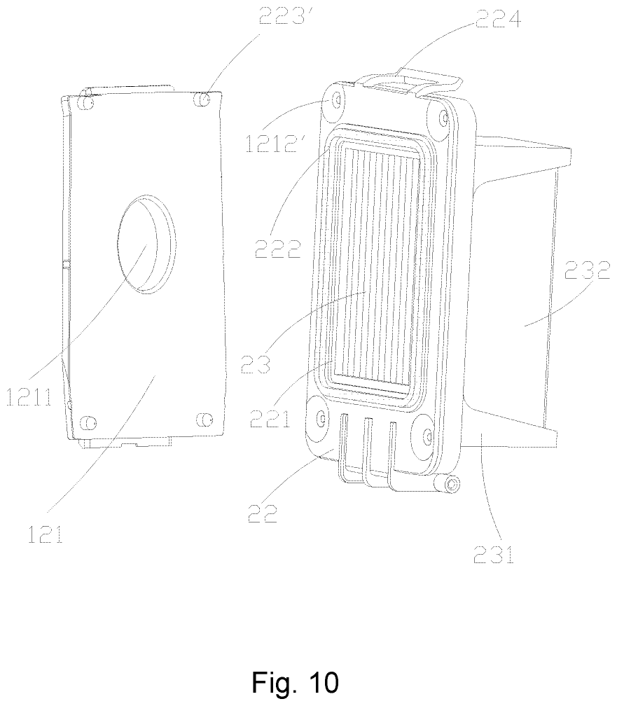

Referring to FIG. 9 again which shows a second embodiment of the present disclosure, compared with the first embodiment, the outer surface of the first side wall 121 is provided with the sealing gasket 222 protruding outwards and four protruding parts 223′ located at peripheries of corners of the sealing gasket 222 and protruding outwards, the protruding parts 223′ are higher than the sealing gasket 222, and the buckle plate 22 is provided with clamping grooves 1212′ recessed inwards along an outer surface and matched with the protruding parts 223′. Referring to FIG. 10, in other embodiments, the sealing gasket 222 may be arranged on the outer surface of the buckle plate 22. The outer surface of the first side wall 121 of the connecting part 12 is provided with the protruding parts 223′ higher than the sealing gasket 222, and the buckle plate 22 is provided with the clamping grooves 1212′ recessed inwards along the outer surface and matched with the protruding parts 223′; and when the dust collection box 20 is inserted into the dust collection body 10, the protruding parts 223′ slide along the outer surface of the buckle plate 22, such that the friction between the first side wall 121 or the buckle plate 22 and the sealing gasket 222 can be isolated, thereby greatly reducing the physical wear of the sealing gasket 222 and prolonging the service life of the sealing gasket 222.

The present disclosure is not limited to the above specific embodiments. Those of ordinary skill in the art can readily understand that there are still many alternative solutions for the dust collection device according to the present disclosure without departing from the principle and scope of the present disclosure. The scope of protection of the present disclosure is subject to the content of the claims.

1. A dust collection device, comprising a dust collection body and a dust collection box inserted into the dust collection body, wherein the dust collection body has a connecting part for accommodating the dust collection box and a ventilation chamber located in the dust collection body, the connecting part has a first side wall attached to the dust collection box, and the first side wall is provided with an opening communicating with the ventilation chamber; the dust collection box has a dust collection seat and a buckle plate arranged on the dust collection seat in a covering manner, and the buckle plate is provided with a penetrating hole matched with the opening and communicating with the dust collection box; an outer surface of at least one of the buckle plate and the first side wall is provided with a sealing gasket protruding outwards;
the outer surface of one of the buckle plate and the first side wall is provided with protruding parts protruding outwards, and the other one is provided with clamping grooves recessed inwards along an outer surface and matched with the protruding parts;
when the dust collection box is inserted into the dust collection body, the protruding parts slide along the outer surface of one of the first side wall and the buckle plate, to isolate the friction between the first side wall or the buckle plate and the sealing gasket; and
when the dust collection box is completely inserted into the dust collection body, the protruding parts are clamped in the clamping grooves, and the sealing gasket is hermetically connected to the opening and the penetrating hole.

2. The dust collection device according to claim 1, wherein the sealing gasket and the protruding parts protrude outwards from the outer surface of the buckle plate; and the clamping grooves are recessed inwards from the outer surface of the first side wall.

3. The dust collection device according to claim 1, wherein the dust collection box further comprises an elastic pad hermetically connected between the dust collection seat and the buckle plate; and when the dust collection box is inserted into the dust collection body, the elastic pad pushes and presses the buckle plate towards the dust collection body.

4. The dust collection device according to claim 1, wherein the buckle plate is pivotally or detachably connected to the dust collection seat.

5. The dust collection device according to claim 1, wherein the protruding parts are arranged at a periphery of the sealing gasket and are higher than the sealing gasket.

6. The dust collection device according to claim 5, wherein the sealing gasket is in the shape of a quadrangle; and the four protruding parts are distributed at peripheries of corners of the quadrangle.

7. The dust collection device according to claim 1, wherein a motor is arranged in the ventilation chamber; a filter assembly is accommodated in the dust collection box, is connected to an inner surface of the buckle plate, and blocks the penetrating hole; and the motor generates a negative pressure to suck in an airflow from the dust collection box, and the airflow sequentially passes through the filter assembly, the penetrating hole, the sealing gasket, and the opening.

8. The dust collection device according to claim 1, wherein the sealing gasket and the protruding parts protrude outwards from the outer surface of the first side wall; and the clamping grooves are recessed inwards from the outer surface of the buckle plate.

9. The dust collection device according to claim 1, wherein the sealing gasket protrudes outward and the clamping grooves are recessed inwards from the outer surface of the buckle plate; and the protruding parts protrude outwards from the outer surface of the first side wall.

10. The dust collection device according to claim 1, wherein the sealing gasket protrudes and the clamping grooves are recessed inwards from the outer surface of the first side wall; and the protruding parts protrude outwards from the outer surface of the buckle plate.

11. The dust collection device according to claim 1, wherein the dust collection device comprises a telescopic assembly for sucking dust;
and the telescopic assembly is at least partially accommodated in the dust collection body, is connected to the dust collection body in a relative sliding manner, and communicates with the dust collection box and the ventilation chamber.

12. The dust collection device according to claim 2, wherein the dust collection device comprises a telescopic assembly for sucking dust; and the telescopic assembly is at least partially accommodated in the dust collection body, is connected to the dust collection body in a relative sliding manner, and communicates with the dust collection box and the ventilation chamber.

13. The dust collection device according to claim 3, wherein the dust collection device comprises a telescopic assembly for sucking dust; and the telescopic assembly is at least partially accommodated in the dust collection body, is connected to the dust collection body in a relative sliding manner, and communicates with the dust collection box and the ventilation chamber.

14. The dust collection device according to claim 4, wherein the dust collection device comprises a telescopic assembly for sucking dust; and the telescopic assembly is at least partially accommodated in the dust collection body, is connected to the dust collection body in a relative sliding manner, and communicates with the dust collection box and the ventilation chamber.

15. The dust collection device according to claim 5, wherein the dust collection device comprises a telescopic assembly for sucking dust; and the telescopic assembly is at least partially accommodated in the dust collection body, is connected to the dust collection body in a relative sliding manner, and communicates with the dust collection box and the ventilation chamber.

16. The dust collection device according to claim 6, wherein the dust collection device comprises a telescopic assembly for sucking dust; and the telescopic assembly is at least partially accommodated in the dust collection body, is connected to the dust collection body in a relative sliding manner, and communicates with the dust collection box and the ventilation chamber.

17. The dust collection device according to claim 7, wherein the dust collection device comprises a telescopic assembly for sucking dust; and the telescopic assembly is at least partially accommodated in the dust collection body, is connected to the dust collection body in a relative sliding manner, and communicates with the dust collection box and the ventilation chamber.

18. The dust collection device according to claim 8, wherein the dust collection device comprises a telescopic assembly for sucking dust; and the telescopic assembly is at least partially accommodated in the dust collection body, is connected to the dust collection body in a relative sliding manner, and communicates with the dust collection box and the ventilation chamber.

19. The dust collection device according to claim 9, wherein the dust collection device comprises a telescopic assembly for sucking dust; and the telescopic assembly is at least partially accommodated in the dust collection body, is connected to the dust collection body in a relative sliding manner, and communicates with the dust collection box and the ventilation chamber.

20. The dust collection device according to claim 10, wherein the dust collection device comprises a telescopic assembly for sucking dust; and the telescopic assembly is at least partially accommodated in the dust collection body, is connected to the dust collection body in a relative sliding manner, and communicates with the dust collection box and the ventilation chamber.
